(19) United States
(12) Patent Application Publication
(10) Pub. No.: US 2024/0409066 A1
(43) Pub. Date: Dec. 12, 2024

(54) CLEANING NOZZLE(S) FOR SENSORY AND/OR ILLUMINATION SYSTEMS OF VEHICLES

(71) Applicant: 1864575 Alberta Ltd. (operating as Safelight Cleaning System), Grande Prairie (CA)

(72) Inventors: Kenton Troy Rycroft, Grande Prairie (CA); Alihossein Nikkhah, Edmonton (CA); Grant Allan Purdue, Prince George (CA)

(73) Assignee: 1864575 Alberta Ltd. (operating as Safelight Cleaning System), Grande Prairie (CA)

(21) Appl. No.: 18/740,214

(22) Filed: Jun. 11, 2024

Related U.S. Application Data
(60) Provisional application No. 63/507,677, filed on Jun. 12, 2023.

(51) Int. Cl. B60S 1/54

(52) U.S. Cl. CPC B60S 1/54

(57) ABSTRACT

A cleaning system for a vehicle having a vehicle structural member, a vehicle electronic device, and a source of pressurized fluid, comprises at least one housing assembly and at least one nozzle assembly. The at least one housing assembly comprises a housing system adapted to be supported by the vehicle structural member and a transmission structure defining a transmission surface. The transmission structure is supported by the housing system to define a housing chamber sized and dimensioned to contain the vehicle electronic device. The at least one nozzle assembly is configured to be supported by the at least one housing assembly adapted to be operatively connected to the source of pressurized fluid. The at least one nozzle assembly is arranged to direct a stream of the pressurized fluid from the source of pressurized fluid onto the transmission surface of the transmission structure.

### RELATED APPLICATIONS

This application (Attorney's Ref. No. P220507) claims benefit of U.S. Provisional Application Ser. No. 63/507,677 filed Jun. 12, 2023, the contents of which are incorporated herein by reference.

### TECHNICAL FIELD

This invention relates to cleaning systems and methods for removing foreign substances from surfaces to permit signal waves to be received and/or transmitted by a vehicle electronic device associated with the vehicle and, more specifically, to cleaning systems and methods adapted to use pressurized air from the vehicle's onboard compressed air system to facilitate functioning of such vehicle electronic devices.

### BACKGROUND

Vehicles are often used in conditions that create a buildup of foreign debris such as snow, dust, or mud onto surfaces of the vehicle. Some surfaces are associated with lights or sensors and should remain clear of debris that might otherwise interfere with proper operation of the lights or sensors.

Cleaning systems are available for some segments of industry to keep windshields clear with a water based solution and a mechanical wiper, others rely mainly on the solvent ability of water to rinse loose debris from headlights or cameras.

Large segments of the transportation and heavy equipment industries use onboard pneumatic systems to operate their service and emergency braking systems. This provides a supply of compressed air that can also be made available for cleaning purposes. This air can be diverted in a controlled manner with the use of control valves, conduits, nozzles, and housings onto desired surfaces with the intention of clearing foreign debris.

### RELATED ART

This invention improves upon CAN Pat. 2,636,337; U.S. Pat. No. 8,087,122 for Cleaning Systems and Methods for Removing Foreign Substances from Designated Surfaces on Vehicles.

### SUMMARY

The current invention may be described as the integration of fluid passages into the body of an illuminating light, camera housing, ultrasonic sensor or other appurtenance, which will be referred to herein as a vehicle electronic device, used in the control or lighting system of a vehicle which contains an onboard pneumatic system.

Activation of the control system will direct compressed air through the system conduits and into the nozzle and housing integrated in the vehicle electronic device. The nozzle is designed such that the orifice area and shape determine the mass flow and coverage area of the compressed air which is then used to force foreign debris from a surface associated with the vehicle electronic device.

The present invention may thus be embodied as a cleaning system for a vehicle having a vehicle structural member, a vehicle electronic device, and a source of pressurized fluid, comprises at least one housing assembly and at least one nozzle assembly. The at least one housing assembly comprises a housing system adapted to be supported by the vehicle structural member and a transmission structure defining a transmission surface. The transmission structure is supported by the housing system to define a housing chamber sized and dimensioned to contain the vehicle electronic device. The at least one nozzle assembly is configured to be supported by the at least one housing assembly adapted to be operatively connected to the source of pressurized fluid. The at least one nozzle assembly is arranged to direct a stream of the pressurized fluid from the source of pressurized fluid onto the transmission surface of the transmission structure.

The present invention may also be embodied as an electronics device support system for a vehicle having a vehicle structural member, a vehicle electronic device, and a source of pressurized fluid, the electronics device support system comprising a housing assembly and at least one nozzle assembly. The housing assembly comprises a housing structure adapted to be supported by the vehicle structural member and a transmission structure defining a transmission surface. The transmission structure is supported by the housing structure to define a housing chamber sized and dimensioned to contain the vehicle electronic device. The at least one nozzle assembly defines at least one nozzle opening, where the at least one nozzle assembly is configured to be supported by the at least one housing assembly and adapted to be operatively connected to the source of pressurized fluid. The at least one nozzle opening is configured to direct the stream of pressurized fluid from the source of pressurized fluid onto the transmission surface in a stream pattern.

The present invention may also be embodied as a method for cleaning a visible surface of a vehicle having a vehicle structural member, a vehicle electronic device, and a source of pressurized fluid, comprising the following steps. A housing structure is secured to the vehicle structural member. The transmission structure has a transmission surface and is secured to the housing structure to define a housing chamber. The vehicle electronic device is arranged within the housing chamber. The at least one nozzle assembly is configured to be supported by the housing structure. The at least one nozzle assembly is adapted to be connected to the source of pressurized fluid. The at least one nozzle assembly is arranged to direct a stream of the pressurized fluid from the source of pressurized fluid onto the transmission surface of the transmission structure. The source of pressurized fluid is controlled to cause pressurized fluid to flow through the at least one nozzle assembly to clean the transmission visible surface of a vehicle.

### BRIEF DESCRIPTION OF THE DRAWINGS

FIG. 1 is a somewhat schematic top plan view of a portion of a vehicle incorporating a fluid control system and a first example cleaning system constructed in accordance with the principles of the present invention;

FIG. 2 is a rear elevational view of the first example cleaning system taken along lines 2-2 in FIG. 1;

FIG. 3 is a schematic illustration of the first example cleaning system integrated with an example fluid control system;

FIG. 4 is a side elevation cross-sectional view of the first example cleaning system taken along lines 4-4 in FIG. 2;

FIG. 5 is a view taken along lines 5-5 in FIG. 4;

FIG. 6 is a somewhat schematic top plan view of a portion of a vehicle incorporating a fluid control system and a second example cleaning system constructed in accordance with the principles of the present invention;

FIG. 7 is a rear elevational view of the second example cleaning system taken along lines 7-7 in FIG. 6;

FIG. 8 is a rear plan view of the second example cleaning system similar to that of FIG. 7;

FIG. 9 is a side view of the second example cleaning system with a transmission structure attached taken along lines 9-9 in FIG. 8;

FIG. 10 is a side view of the second example cleaning system similar to FIG. 9 with the transmission structure detached;

FIG. 11 is rear perspective view of a housing structure the second example cleaning system;

FIG. 12 is an front perspective view of the housing structure of the second example cleaning system;

FIG. 13 is a side plan elevation view of the second example cleaning system;

FIG. 14 is a bottom plan elevation view of the second example cleaning system;

FIG. 15 is a close-up side cross-sectional view of a first example nozzle structure taken along lines 15-15 in FIG. 8;

FIG. 16 is a close-up side cross-sectional view of a second example nozzle structure taken along lines 16-16 in FIG. 8;

FIG. 17 is a close-up cross sectional top view of the first example nozzle assembly taken along lines 17-17 in FIG. 15;

FIG. 18 is a close-up cross sectional top view of the second example nozzle assembly taken along lines 18-18 in FIG. 16; and

FIG. 19 is a side cross sectional view of a third example cleaning system of the present invention.

### DETAILED DESCRIPTION

### I. First Example

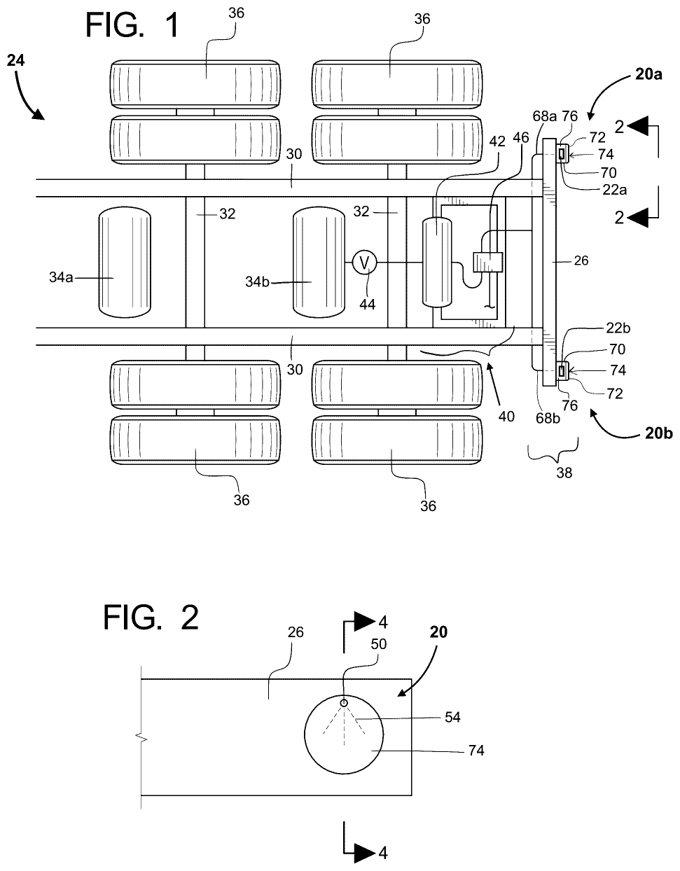

Referring initially to FIG. 1 of the drawing, depicted therein is a first example cleaning system 20 constructed in accordance with, and embodying, the principles of the present invention. The first example cleaning system 20 is configured to remove foreign substances from targeted transmission surfaces to facilitate operation of at least one electronic device 22 of a vehicle 24. The example cleaning system 20 is configured to be secured to at least one structural member 26 defined by the vehicle 24, and the vehicle electronic device(s) 22 generate signal waves 28.

The example vehicle 24 comprises a frame 30, axles 32, a vehicle braking system (not shown) comprising one or more air tanks 34, wheels 36, and a bumper 38. The vehicle structural member 26 is typically formed on the frame 30 or a component rigidly secured to the frame 30 such as the bumper 38. The vehicle 24 is or can be conventional and will be described herein only to the extent necessary for a complete understanding of the present invention; only a portion of the vehicle is depicted in FIG. 1.

The first example cleaning system 20 can be incorporated to a fluid control system 40 and rigidly connected to the vehicle structural member 26 of the vehicle 24. The example fluid control system 40 comprises an accumulator 42, a bleed valve assembly 44, a control valve assembly 46, and a control switch 48. The example cleaning system 20 comprises at least one nozzle system 50 and at least one housing system 52. The example nozzle system 50 directs a stream 54 of pressurized fluid at or along at least a portion of the housing system 52 as will be described in further detail below.

The example nozzle system 50 comprises a nozzle structure 60 defining a nozzle opening 62, a nozzle receiver 64 defining a nozzle chamber 66, and a conduit 68 operatively connected between the nozzle receiver 64 and the fluid control system 40. The example housing system 52 is an assembly comprising a housing structure 70 and a transmission structure 72 defining a transmission surface 74. The housing structure 70 and the transmission structure 72 can be detachably attached to each other to define a housing chamber 76.

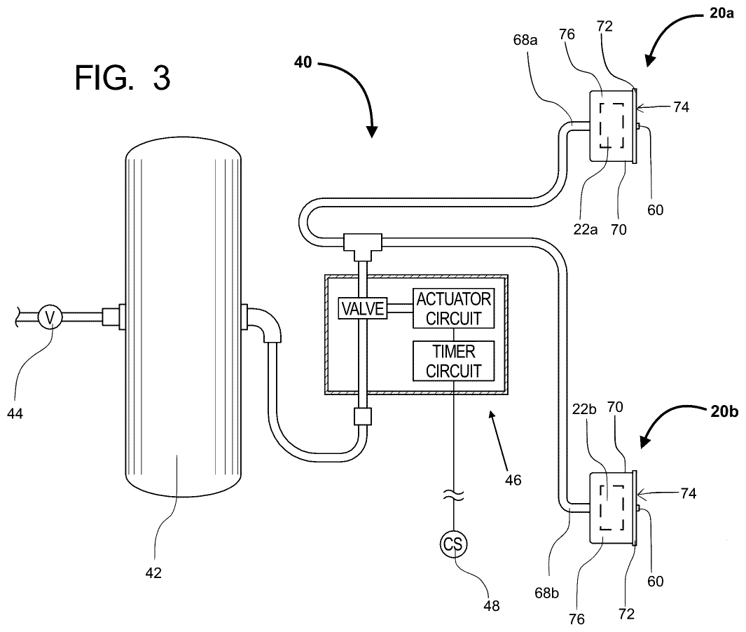

As depicted in FIGS. 1 and 3, the fluid control system 40 can incorporate or be operatively connected to one or more first example cleaning systems 20 referred to herein as first and second cleaning sub-systems 20a and 20b. Each of the first example cleaning sub-systems 20a and 20b is associated with designated vehicle electronic devices 22a and 22b. The first example cleaning sub-systems 20a and 20b can be mounted on one or more vehicle structural member(s) 26. While the preferred embodiment of the present invention utilizes two first example cleaning sub-systems 20a and 20b, a single or more than two first example cleaning systems 20 can be used. In the example with first and second cleaning sub-sub-systems 20a and 20b, first and second conduits 68a and 68b are arranged between the first and second cleaning sub-sub-systems 20a and 20b and the fluid control system 40.

The first example cleaning sub-systems 20a and 20b are operatively connected to a fluid control system 40. The fluid control system 40 can operate as described in U.S. Pat. No. 8,807,122 and CAN Pat. 2,636,337. The fluid control system 40 will thus only be described herein to the extent necessary for a complete understanding of the present invention.

The example fluid control system 40, as shown in FIGS. 1 and 3, is operatively connected to an air brake system (not shown in its entirety) comprising one or both of the air tanks 34. The air brake system is or can be conventional and will not be described herein beyond the extent necessary for a complete understanding of the present invention. The fluid control system 40 operates by utilizing pressurized air from one or both of the air tanks 34 of the air brake system.

During normal operation of the brake system, the air tanks 34a and 34b fill with pressurized air. The example fluid control system 40 provides the first example cleaning system 20 with the source of pressurized fluid. In particular, pressurized fluid flows through the fluid control system 40 and into conduits 68a and 68b. The first example cleaning sub-systems 20a and 20b are connected to the fluid control system 40 by the conduits 68a and 68b. The conduits 68a and 68b are or can be conventional piping with associated fittings, seals, and the like capable of conveying fluids as discussed herein. The example conduits 68a and 68b are connected to the corresponding receivers 64a and 64b as will be described in further detail below.

As shown in FIGS. 1 and 2, the first example cleaning sub-systems 20a and 20b are rigidly connected to a vehicle structural member 26. The first example cleaning system 20 is cylindrical in shape having a base that rests against the vehicle structural member 26 and an exterior face opposite of the base. The height h and diameter d of the first example cleaning systems are or can be dimensioned to fit a desired vehicle electronic device 22 to be associated with the cleaning sub-systems 20a and 20b. The first example cleaning sub-systems 20a and 20b can be any shape such as a square, rectangle, or other shape.

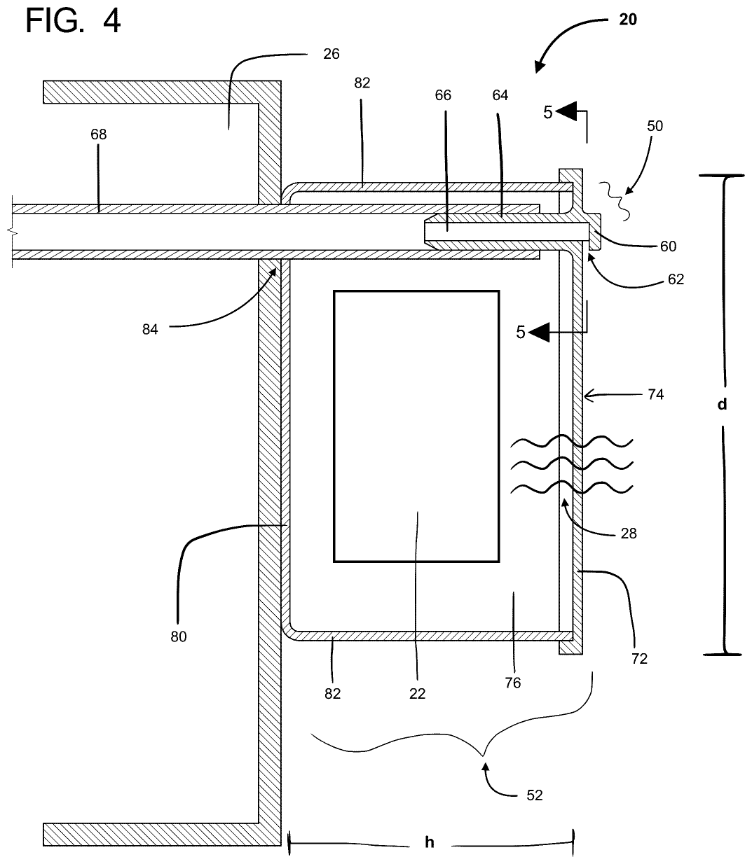

FIG. 4 depicts a side cross-sectional view of the first example cleaning system 20a. For the purpose of this explanation, the first example cleaning system 20b (not pictured in FIG. 4) can be constructed and operated in the same manner as the first example cleaning system 20a, as described herein. Alternatively, only one cleaning system 20 can be used, or the cleaning sub-systems 20a and 20b can be configured differently as required by the vehicle electronic devices 22 associated therewith. In this context, the vehicle electronic devices 22 can include or be formed by one or more devices capable of sending and/or receiving the signal waves 28, including but not limited to one or more of a light, a camera, a radar system, a lidar system, a sonic device, or other similar devices that can detect or emit signal waves 28. As examples, the signal waves 28 can be electromagnetic or sound waves.

The first example cleaning system 20 comprises a nozzle system 50 and a housing system 52.

The example housing structure 70 is configured to define a base 80 and walls 82 that at least partly define the housing chamber 76. The housing structure 70 becomes enclosed when the transmission structure 72 is attached to the housing structure 70.

The example housing system 52 is sized and dimensioned such that the vehicle electronic device 22 may be contained within the housing chamber 76. The base 80 of the example housing structure 70 lays flush against the vehicle structural member 26, and the walls 82 of the example housing structure 70 extend away from the vehicle structural member 26. In particular, the housing structure 70 may be rigidly connected to the vehicle structural member 26 through the base 80 of the housing structure 72. The housing structure 70 can be connected to the vehicle structural member 26 using screws, magnets, or other suitable connection mechanisms. The example housing structure 70 further defines an opening 84 for a conduit 68 to pass through and connect to the receiver 64, as will be explained further below.

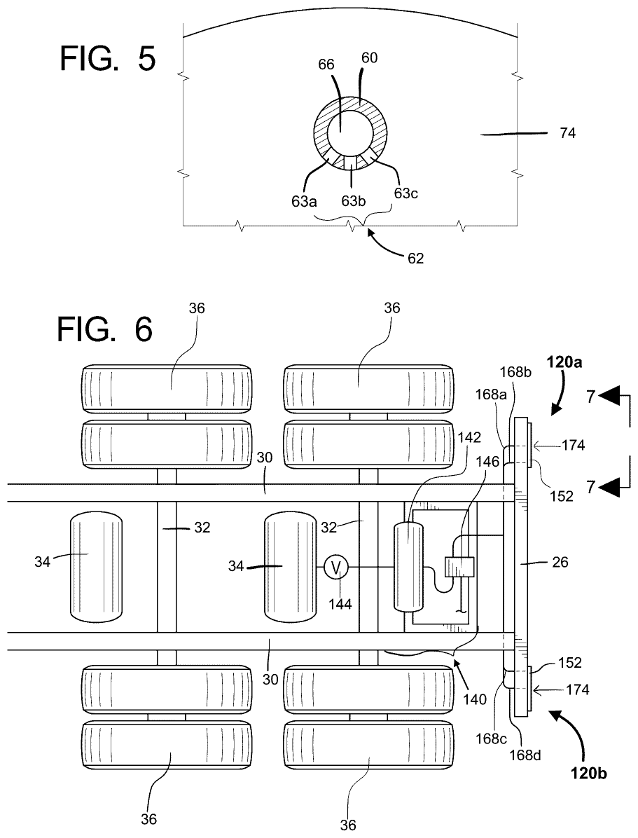

As shown in FIG. 4, the housing structure 70 supports the transmission structure 72. The example transmission structure 72 is shaped to fit flush on the exterior face of the first example cleaning system 20. As shown the first example cleaning system 20, the transmission structure 72 functions as a lid and can be attached to the housing structure 70 using any type of screw, latch release, magnetic, snap-fit, adhesive or other suitable attachment system or mechanism. The transmission structure 72 defines the transmission surface 74, shown in FIGS. 2 and 5. The transmission surface 74 is the surface that is targeted when using the first example cleaning system 20 is operated to remove foreign substances. The example transmission structure 72 further defines the nozzle structure 60 and the receiver 64, explained in more detail below.

The transmission surface 74 permits the vehicle electronic device 22 to send or receive the signal waves 28 from within the housing system 52. The transmission surface 74 can be any material that permits signal waves 28 to penetrate such as glass, plastic, fabric, or other similar materials. The transmission surface 74 can further be perforated or made of a mesh material as appropriate for the signal waves sent and/or received by the electronic device 22. The transmission surface 74 can further utilize reflective, LED (light-emitting diode), or other similar materials to facilitate transmission of the signal waves 28.

As shown in FIG. 4, the example nozzle structure 60 and the receiver 64 are defined by, incorporated with, or otherwise integrally formed by the transmission structure 72.

The nozzle structure 60 and nozzle opening 62 are configured to extend beyond the exterior face of the transmission surface 74 and the receiver 64 extends towards the interior of the housing system 52 in order to connect to conduit 68. The receiver 64 is cylindrically shaped with a hollow interior defining a nozzle chamber 66. The receiver 64 can connect to the conduit 68 through any tube style attachment, such as a sleeve, male or female end fittings, reducer fitting, or other similar mechanism. When the fluid control system 40 directs fluids into the conduit 68, the fluids flow from the conduit 68 through the nozzle chamber 66 in the receiver 64, as shown by the fluid directional arrow 128, and out the nozzle opening 62 of the nozzle structure 60.

The example nozzle structure 60 defines the nozzle opening 62 whereby the nozzle opening 62 is the outlet for the stream 54 of pressurized fluid that passes through the nozzle system 50. The nozzle opening 62 is oriented to direct a stream 54 of pressurized fluid onto the transmission surface 74. In the preferred embodiment of the first example cleaning system 20, the nozzle system 50 is positioned adjacent to the outer edge of the housing system 52, and the nozzle opening 62 directed towards the greatest surface area of the transmission surface 74, as shown in FIGS. 2 and 4. The nozzle opening 62 can further include multiple vents 63a, 63b, and 63c, to further control or direct the direction in which the pressurized fluid 54 is dispersed from the nozzle structure 60, as shown in FIG. 5.

The first example cleaning system 20 operates basically as follows. The first example cleaning system 20 is rigidly connected to a vehicle structural member 26. Designated vehicle electronic devices 22a and 22b are contained within the housing structure 70 and behind the transmission surface 74.

During normal operation of the brake system, fluids from the source of pressurized air flow through the fluid control system 40. The fluid control system 40 then directs pressurized fluid through the conduits 68, the nozzle systems 50, and out of the nozzle structures 60 through the nozzle openings 62 in the stream 54 of pressurized fluid. The stream 54 of pressurized fluid then flows onto the transmission surface 74. The streams 54 of pressurized fluid then remove debris and foreign substances from the transmission surface 74.

### II. Second Example

Referring now to FIGS. 6-18 of the drawing, depicted therein is a second example cleaning system 120 constructed in accordance with, and embodying, the principles of the present invention. Like the first example cleaning system 20, the second example cleaning system 120 is configured to remove foreign substances from a targeted surface to facilitate operation of one or more vehicle electronic devices 22. In the example depicted in FIG. 6, the vehicle employs multiple vehicle electronic devices 22 (not depicted in FIG. 6), as will be described further below.

The second example cleaning system 120 is operatively connected to a fluid control system 140, as shown in FIGS. 6 and 8 and rigidly connected to a vehicle structural member 26. The fluid control system 140 can integrate at least two second example cleaning systems 120, referred to herein as second example cleaning sub-systems 120a and 120b that contain designated vehicle electronic devices 22. The second example cleaning sub-systems 120a and 120b can be mounted on the vehicle structural member 26. While the preferred embodiment of the present invention utilizes two second example cleaning sub-systems 120a and 120b, a single or more than two second example cleaning systems 120 can be used. In addition, the second example cleaning sub-systems 120a and 120b are identical, and only the cleaning sub-system 120a will be described herein in detail. However, the cleaning sub-systems 120a and 120b need not be identical and may take different configurations as appropriate for the particular electronic device 22. The second example cleaning system 120 is connected to the fluid control system 140 by conduits 168a, 168b, 168c, and 168d.

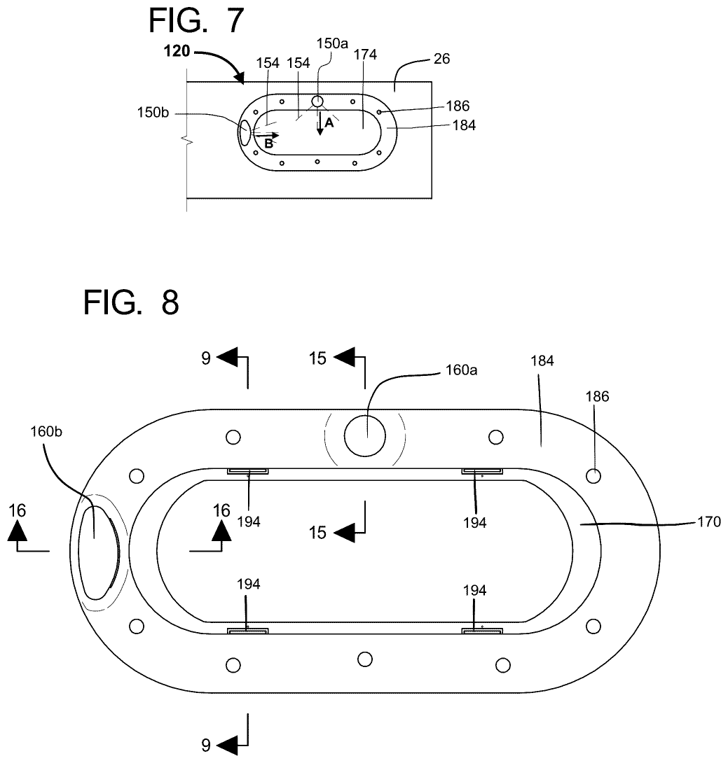

As shown in FIGS. 6 and 7, the second example cleaning sub-systems 120a and 120b are rigidly connected to the vehicle structural member 26. The second example cleaning system 120 is configured to be an oblong shape having straight and curved edges. Although the oblong shape is the preferred embodiment for the present invention, the shape of the second example cleaning system 120 can be configured to be circular, square, rectangular, triangular, or other geometric shape. The second example cleaning system 120 has a base that lays flush against the vehicle structural member 26 and an exterior face opposite of the base. The size and dimensions of the second example cleaning system 120 can be varied to accommodate the desired vehicle electronic device 22.

The example fluid control system 140 comprises an accumulator 142, a bleed valve assembly 144, a control valve assembly 146, and a control switch 148. The second example cleaning system 120 comprises at least one nozzle system 150 and at least one housing system 152. The example nozzle system 150 directs at least one stream 154 of pressurized fluid at or along at least a portion of the housing system 152 as will be described in further detail below.

The example nozzle system 150 comprises at least one nozzle structure 160 defining a nozzle opening 162, at least one a nozzle receiver 164 defining a nozzle chamber 166, and a conduit 168 operatively connected between the nozzle receiver 164 and the fluid control system 140. The example housing system 152 is an assembly comprising a housing structure 170 and a transmission structure 172 defining a transmission surface 174. The example housing structure 170 and the transmission structure 172 can be detachably attached to each other to define a housing chamber 176. The example housing structure 170 further defines or supports the nozzle opening 162 and the nozzle receiver 164. The example housing structure 170 is further configured to define a base 180 and walls 182 that extend from the base 180 to at least partly define the housing chamber 176. The housing structure 170 becomes enclosed when the transmission structure 172 is attached to the housing structure 170.

FIGS. 8, 11, and 12 illustrate that the second example cleaning system 120 comprises first and second nozzle systems 150a and 150b and one housing system 152. The second example cleaning system 120 thus defines four of the nozzle openings 162 four of the receivers 164, and four of the nozzle chambers 166. The four receivers 164 are adapted to be operatively connected to four conduits 168a, 168b, 168c, and 168d that are in turn operatively connected to the fluid control system 140. The first and second nozzle systems 150a and 150b of the second example cleaning system 120 thus cause two streams 154 of pressurized fluid to be directed onto each of the transmission surfaces 174 defined by the housing structures 150a and 150b.

The example housing structure 170 is configured such that the walls 182 engage and support the transmission structure 172 to define the housing chamber 176. The housing structure 170 becomes at least partly enclosed when the transmission structure 172 is attached to the housing structure 170, described in more detail below.

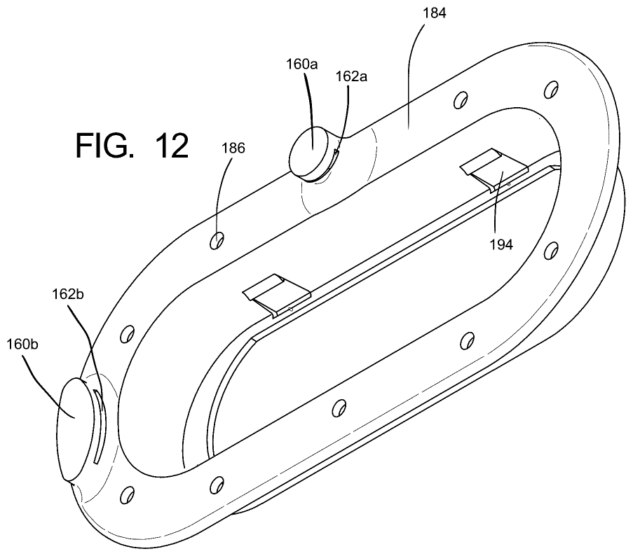

The housing example chamber 176 is sized and dimensioned to contain the electronic device 22. The example base 180 of the housing structure 170 is configured to conform to or lay flush against the vehicle structural member 26, and the walls 182 of the housing structure 170 are configured to extend from the base 180 to support the transmission structure 172 in a desired orientation relative to the structural member 26. As depicted in FIGS. 11 and 12, the base 180 of the housing structure 170 can be configured without a rear wall as required by different configurations of the vehicle 24 and different configurations of vehicle electronic devices 22.

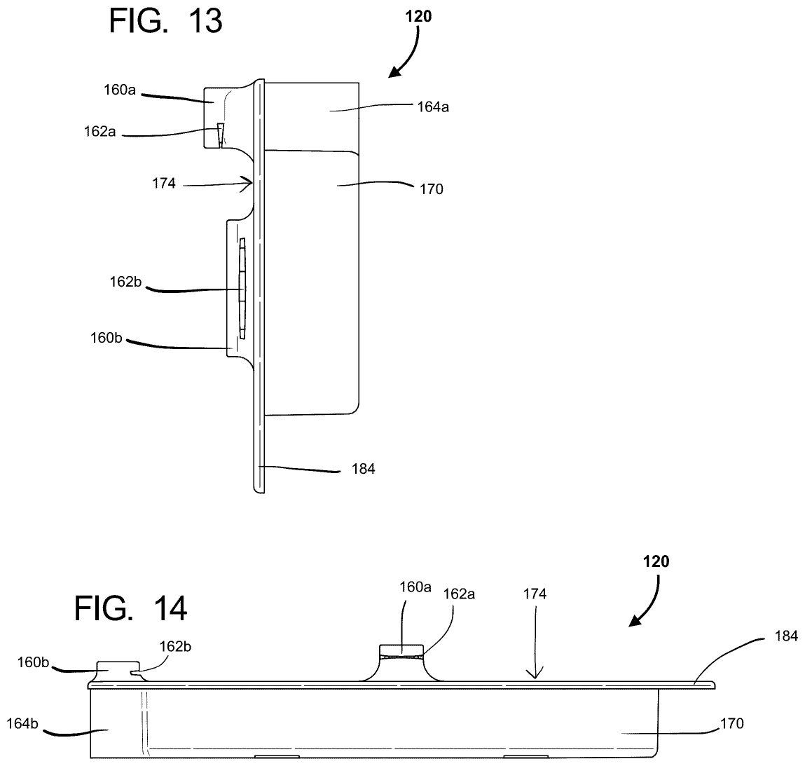

In the example housing system 152, an anchoring wall 184 extends laterally from the walls 182 of the housing structure 170 and is aligned with the exterior face of the second example cleaning system 120, as shown in FIGS. 13 and 14. The anchoring wall 184 includes anchor holes 186 for screws, pins, bolts, or other fastening members to secure the housing assembly to the vehicle structural member 26. Instead or in addition, the anchoring wall 184 may be secured to the vehicle structural member 26 using adhesives, adhesive tape, or the like.

Further, in the second example cleaning system 120, the housing structure 170 supports or incorporates for the receivers 164a and 164b and nozzle structures 160a and 160b of the nozzle systems 150a and 150b, explained in greater detail below.

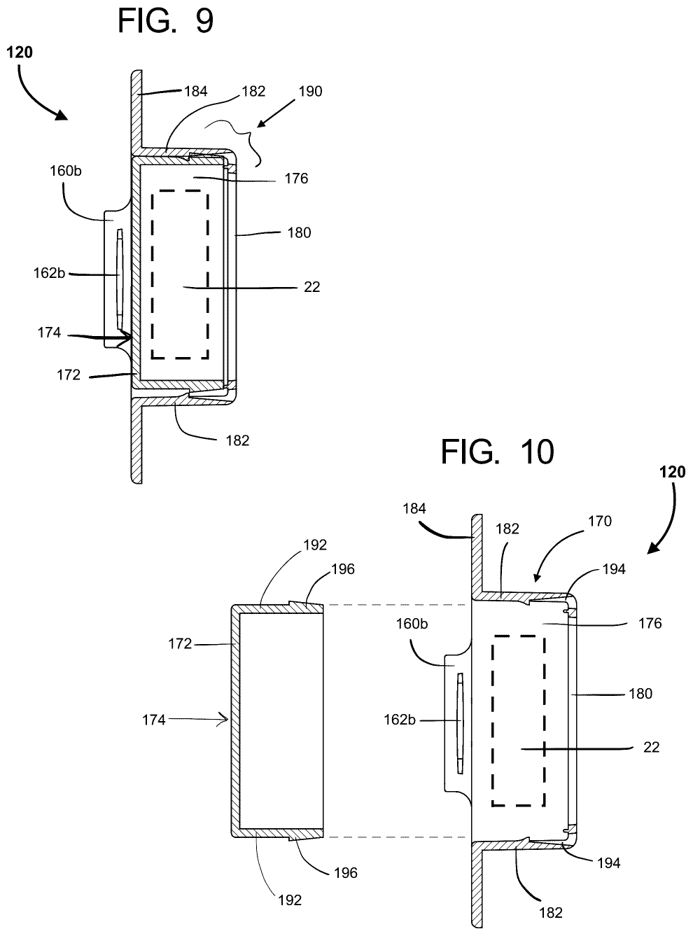

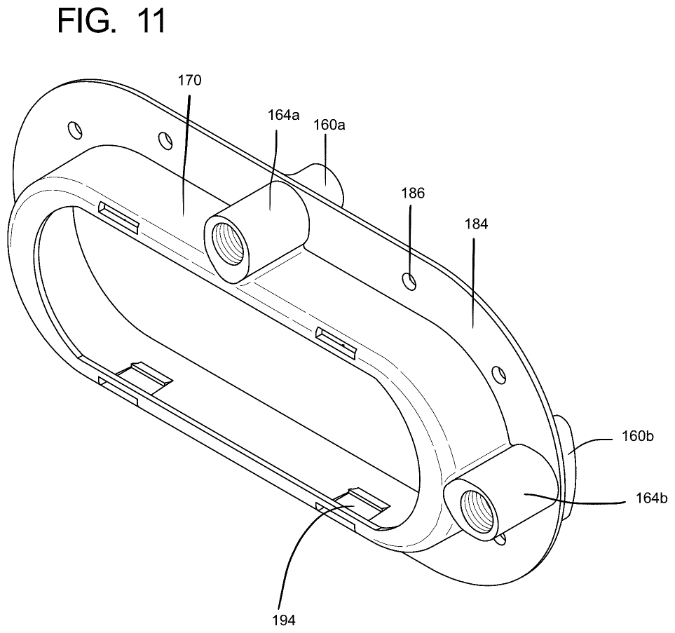

FIG. 9 depicts the second example cleaning assembly 120 with the transmission structure 172 attached to the housing structure 170. FIG. 10 depicts the second example cleaning assembly 120 with the transmission structure 172 separated from the housing structure 170. The example housing system 152 comprises an attachment system 190 for detachably attaching the housing structure 170 and the transmission structure 172. In the example housing system 152, the attachment system 190 comprises a plurality of latch members 192 and a plurality of latch slots or depressions 194. The latch members 192 are resiliently deformable members defining latch projections 196 that, as the transmission structure 172 is displaced relative to the housing structure 170, are deformed from a first position such that the latch projections 196 and then return to the first position to engage the latch slots 194 to fix a location of the transmission structure 172 relative to the housing structure 170. Deforming the latch members 192 in a second direction allows the latch projections 196 to be disengaged from the latch slots 194 to allow the transmission structure 172 to be removed from the housing structure 170. In the example housing system 152, the example latch members 192 are integrally formed with the housing structure 170, and the example latch depressions or slots 194 are formed in the transmission structure 172, but the locations of the latch members 192 and latch slots 194 may be switched.

The example housing structure 170 thus provides support for the transmission structure 172 such that the transmission structure 172 is nested in alignment with the shape of the housing structure 170.

The housing structure 170 thus can be detachably connected to the transmission structure 172 as depicted in FIGS. 9 and 10. The transmission structure 172 connects to the housing structure 180 through a snap-fit mechanism formed by the latch projections 196 and the latch depressions or slots 194. The mechanism used to detachably connect the transmission structure 182 to the housing structure 170 at the attachment location can be a screw, latch release, magnetic, snap-fit, or other related mechanism.

As generally described above, an outer face of the example transmission structure 172 defines the transmission surface 174. When the transmission structure 172 is attached to the housing structure 170, the transmission surface 174 is substantially aligned with or defines the exterior face of the second example cleaning system 120. When the transmission structure 172 is attached to the housing structure 170, the transmission surface 174 is also arranged in a desired orientation relative to the nozzle openings 162a and 162b of the nozzle systems 150a and 150b. Operating the second example cleaning system 120 thus directs the streams 154a and 154b of pressurized fluid onto the transmission surface 174 to remove debris that might otherwise interfere with proper operation of the vehicle electronic device 22.

In particular, when adequately cleaned the transmission surface 174 permits the vehicle electronic device 22 to transmit and/or receive the signal waves 28 contained within the housing system 152. The transmission surface 174 can be any material that permits transmission of the signal waves 28, such as glass, plastic, fabric, or other similar materials. The transmission surface 174 can further be perforated or made of a mesh material as appropriate for the signal waves 28 sent and/or received by the electronic device 22. The transmission surface 174 can further utilize reflective, LED (light-emitting diode), or other similar materials to facilitate transmission of the signal waves 28.

The nozzle systems 150a and 150b are comprised of nozzle structures 160a and 160b defining nozzle openings 162a and 162b, and receivers 164a and 164b that connect to conduits 168a and 168b. The receivers 164a and 164b are supported by the outer walls of the housing structure 170 and the anchoring wall 184. In a preferred embodiment, the first nozzle system 150a is positioned at a first location on an edge of the second example cleaning system 120 and a second nozzle system 150b is positioned at a second location of the edge of the second example cleaning system 120. In particular, the first nozzle system 150a is located at an upper horizontal edge location, the second nozzle system 150b is located at a side, curved but generally vertical edge location. However, in alternative embodiments, the positions of the nozzle assemblies could be move as required by the particular configuration of the housing system 152 and characteristics of the vehicle electronic device 22.

The example receivers 164a and 164b can be generally shaped and extend from the anchoring wall 184 to the base 180 of the housing structure 170. In a preferred embodiment, the receivers 164a and 164b can be internally or externally threaded to facilitate connection of the conduits 168a and 168b to the receivers 164a and 164b, although alternative embodiments could include any suitable method of attaching a source of compressed fluid to the receivers 164a and 164b.

The example nozzle structures 160a and 160b protrude from the anchoring wall 184 and define the nozzle openings 162a and 162b. The nozzle openings 162a and 162b are positioned above the transmission surface 174, as depicted in FIGS. 12 to 14. The dimensions and shape of the nozzle structures 160a and 160b will be determined such that the stream or streams 154 of pressurized fluid are in a stream pattern that optimizes removal of dirt and debris from the transmission surface 174. Typically, each stream pattern comprises one or more flat, fan-shaped streams configured to provide desirable coverage over the transmission surface 174.

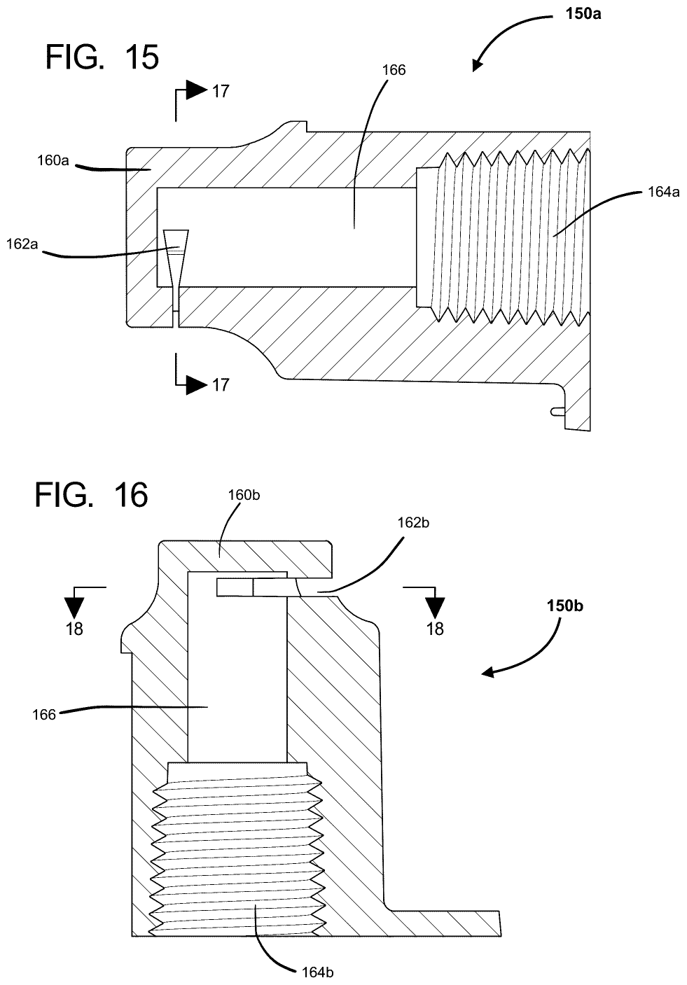

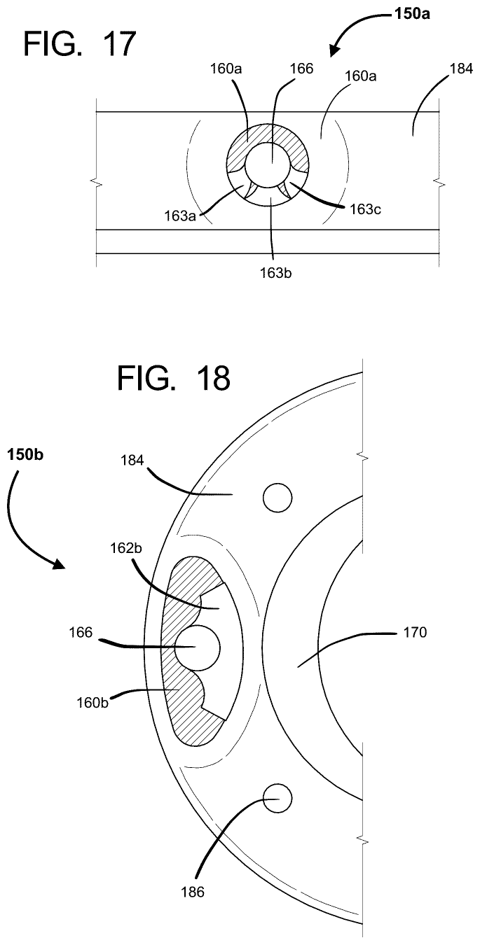

The nozzle opening 162a is defined by the nozzle structure 160a, depicted up close in FIGS. 15 and 17. The first nozzle structure 160a can be configured to be a greater height than the second nozzle structure 160b and be generally cylindrically shaped. The example nozzle opening 162a defined by the first nozzle structure 160a can be middle-tapered and have three vents 163a, 163b and 163c. The example nozzle opening 162a directs a stream 154 of pressurized fluid onto the transmission surface 174 from a first direction, as shown by directional arrow A in FIG. 7.

The example nozzle opening 162b is defined by the nozzle structure 160b, depicted up close in FIGS. 16 and 18. The second nozzle structure 160b can be configured to be a shorter height than the first nozzle structure 160a. The nozzle opening 162b defined by the second nozzle structure 160b can be a singular uniform opening. The nozzle opening 162b directs a stream 154 of pressurized fluid onto the transmission surface 174 from a second direction as shown by directional arrow B in FIG. 7.

The second example cleaning system 120 operates basically as follows. At least two second example cleaning systems 120a and 120b are rigidly connected to a vehicle structural member 26. Designated vehicle electronic devices 22 are contained within the housing systems 152a and 152b.

During normal operations of the brake system, pressurized fluid or fluids from the source of pressurized fluid flow through the fluid control system 140. The fluid control system 140 then directs pressurized fluid 154 into conduits 168a, 168b, 168c, and 168d. The fluids then flow into the nozzle systems 150a and 150b and out the nozzle openings 162a and 162b defined by the cleaning sub-systems 120a and 120b in fourth pressurized streams 154, with two streams 154 be directed onto the first transmission surface 174a and two streams 154 being directed onto the second transmission surface 174b. The streams of fluid 154 are configured to remove debris and foreign substances from the transmission surfaces 174a and 174b of the second example cleaning sub-systems 120a and 120b.

The method of use for the second example cleaning system 120 includes anchoring at least one housing structure 170 to one or more vehicle structural member(s) 26, and then connecting one transmission structure 172 to each housing structure 170 to define one or more housing chambers 176. The vehicle electronic device 22 is then arranged at least partly within the housing chamber 176. The first nozzle system 150a and the second nozzle system 150b are configured to be supported by the housing structure 170. The first and second nozzle systems 150a and 150b are connected to a source of pressurized fluid through the fluid control system 140. Further, the method for cleaning a visible surface of a vehicle 24 includes arranging the nozzle systems 150a and 150b such that the source of pressurized fluid is directed onto the transmission surfaces 174 of the transmission structures 172a and 172b. The pressurized fluid is directed in one or more stream patterns onto the transmission surface(s) 174 to remove foreign substances.

### III. Third Example

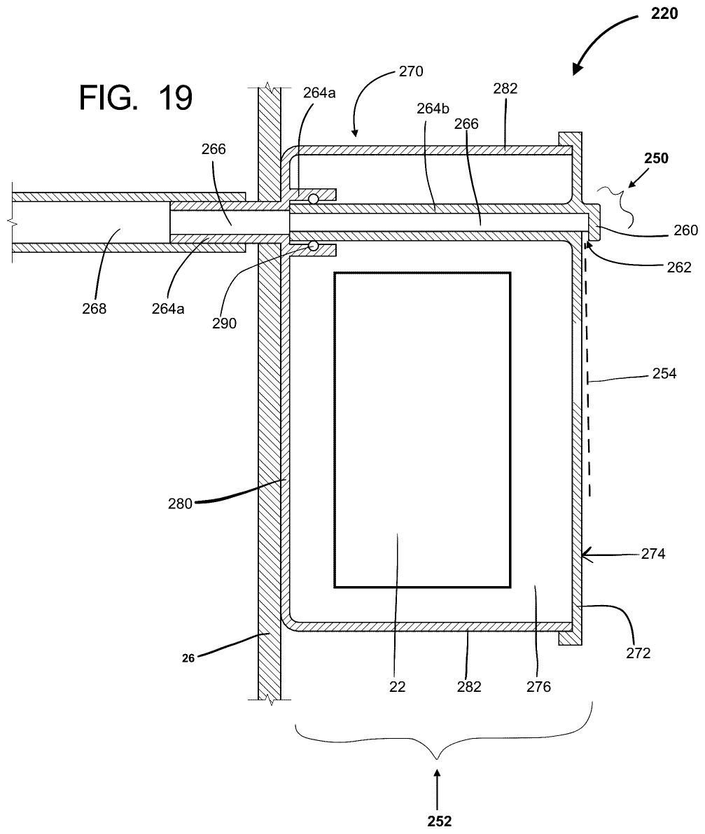

Referring now to FIG. 19, a cross sectional view of a third example cleaning system 220 is depicted. The third example cleaning system 220 is or can interact with the vehicle 24 and fluid control system 40 in the same manner as previously described in connection with the first example cleaning system 20 and/or the second example cleaning system 120. The third example cleaning system 220 will thus be described herein primarily to the extent that the third example cleaning system 220 differs from the first and second example cleaning systems 20 and 120 described above.

The example cleaning system 220 comprises at least one nozzle system 250 and at least one housing system 252. The example nozzle system 250 directs at least one stream 254 of pressurized fluid at or along at least a portion of the housing system 252 as will be described in further detail below.

The example nozzle system 250 comprises at least one nozzle structure 260 defining a nozzle opening 262, at least one a nozzle receiver 264 defining a nozzle chamber 266, and a conduit 268 operatively connected between the nozzle receiver 264 and the fluid control system 240. The example housing system 252 is an assembly comprising a housing structure 270 and a transmission structure 272 defining a transmission surface 274. The example housing structure 270 and the transmission structure 272 can be detachably attached to each other to define a housing chamber 276. The example housing structure 270 is further configured to define a base 280 and walls 282 that extend from the base 280 to at least partly define the housing chamber 276. The housing structure 270 becomes enclosed when the transmission structure 272 is attached to the housing structure 270.

The example nozzle system 250 is defined by or integrally formed with both the housing structure 270 and the transmission structure 272. In particular, the housing structure 270 defines a first nozzle receiver portion 264a, while the transmission structure 272 defines the nozzle opening 262 and a second nozzle receiver portion 264b. The first and second nozzle receiver portions 264a and 264b define the nozzle chamber 266. Further, an optional O-ring 290 may be provided to facilitate a fluid-tight connection between the first and second nozzle receiver portions 264a and 264b.

The third example cleaning system 220 may be used in the same manner as the first and second example cleaning systems 20 and 120 described above. The housing structure 270 is initially mounted onto the structural member 26 of the vehicle 24. The first nozzle receiver portion 264a is then connected by the conduit 268 to the fluid control system 40 (not pictured in FIG. 19). The transmission structure 272 is then either permanently or detachably attached to the housing structure 270 such that a portion of the first nozzle receiver portion 264a engages a portion of the second nozzle receiver portion 264b to form the nozzle chamber 266. The optional O-ring 290 is arranged between portions of the first and second nozzle receiver portions 264a and 264b to facilitate formation of a fluid-tight connection between the first and second nozzle receiver portions 264a and 264b. Operation of the fluid control system 40 to cause pressurized fluid to flow through the conduit 268, through the nozzle chamber 266, and out of the nozzle opening 262 towards the transmission surface 274 in a spray of pressurized fluid configured to remove dirt and/or debris from the transmission surface 274.

What is claimed is:

1. A cleaning system for a vehicle having a vehicle structural member, a vehicle electronic device, and a source of pressurized fluid, comprising:
at least one housing assembly comprising
a housing system adapted to be supported by the vehicle structural member, and
a transmission structure defining a transmission surface, where
the transmission structure is supported by the housing system to define a housing chamber sized and dimensioned to contain the vehicle electronic device; and
at least one nozzle assembly
configured to be supported by the at least one housing assembly, and
adapted to be operatively connected to the source of pressurized fluid; whereby
the at least one nozzle assembly is arranged to direct a stream of the pressurized fluid from the source of pressurized fluid onto the transmission surface of the transmission structure.

2. A cleaning system as recited in claim 1, in which the housing assembly defines an anchoring wall configured to be secured to the vehicle structural member.

3. A cleaning system as recited in claim 1, in which the nozzle assembly comprises at least one nozzle opening defined by at least one of the housing system and the transmission structure, where the at least one nozzle opening is configured to direct the stream of pressurized fluid onto the transmission surface in a stream pattern.

4. A cleaning system as recited in claim 1, in which the nozzle assembly comprises at least one nozzle opening defined by the housing system, where the at least one nozzle opening is configured to direct the stream of pressurized fluid onto the transmission surface in a stream pattern.

5. A cleaning system as recited in claim 1, in which the nozzle assembly comprises at least one nozzle opening defined by the transmission structure, where the at least one nozzle opening is configured to direct the stream of pressurized fluid onto the transmission surface in a stream pattern.

6. A cleaning system as recited in claim 1, in which the cleaning system comprises first and second nozzle assemblies, whereby the housing system supports the first and second nozzle assemblies such that:
the first nozzle assembly is oriented to direct fluids at the transmission surface from a first direction: and
the second nozzle assembly is oriented to direct fluids at the transmission surface from a second direction.

7. A cleaning system as recited in claim 1, in which the housing assembly further comprises an attachment system configured to detachably connect the transmission structure to the housing system.

8. A cleaning system as recited in claim 1, in which signal waves associated with the vehicle electronic device pass through the transmission surface.

9. An electronics device support system for a vehicle having a vehicle structural member, a vehicle electronic device, and a source of pressurized fluid, comprising:
a housing assembly comprising
a housing structure adapted to be supported by the vehicle structural member, and
a transmission structure defining a transmission surface, where
the transmission structure is supported by the housing structure to define a housing chamber sized and dimensioned to contain the vehicle electronic device; and
at least one nozzle assembly defining at least one nozzle opening, where the at least one nozzle assembly is
configured to be supported by the at least one housing assembly, and
adapted to be operatively connected to the source of pressurized fluid; whereby
the at least one nozzle opening is configured to direct the stream of pressurized fluid from the source of pressurized fluid onto the transmission surface in a stream pattern.

10. A cleaning system as recited in claim 9, in which the cleaning system comprises first and second nozzle assemblies, whereby the housing structure supports the first and second nozzle assemblies such that:
the first nozzle assembly is oriented to direct fluids at the transmission surface from a first direction; and
the second nozzle assembly is oriented to direct fluids at the transmission surface from a second direction.

11. A cleaning system as recited in claim 10, in which the first and second nozzle assemblies direct fluids at the transmission surface.

12. A cleaning system as recited in claim 9, in which the housing assembly defines an anchoring wall configured to be secured to the vehicle structural member.

13. A cleaning system as recited in claim 9, in which the housing structure further comprises at least one attachment location that is configured to detachably connect the transmission structure to the housing structure.

14. A cleaning system as recited in claim 9, in which signal waves associated with the vehicle electronic device pass through the transmission surface.

15. A method for cleaning a visible surface of a vehicle having a vehicle structural member, a vehicle electronic device, and a source of pressurized fluid, comprising the steps of:
securing a housing structure to the vehicle structural member;
connecting a transmission structure having a transmission surface to the housing structure to define a housing chamber;
arranging the vehicle electronic device within the housing chamber;
configuring at least one nozzle assembly to be supported by the housing structure;
adapting the at least one nozzle assembly to be connected to the source of pressurized fluid;
arranging the at least one nozzle assembly to direct a stream of the pressurized fluid from the source of pressurized fluid onto the transmission surface of the transmission structure; and
controlling the source of pressurized fluid to cause pressurized fluid to flow through the at least one nozzle assembly to clean the transmission visible surface of a vehicle.

16. A method for cleaning a visible surface of a vehicle as recited in claim 15, in which the step of connecting the transmission structure to the housing structure comprises the step of arranging an attachment system to detachably connect the transmission structure to the housing structure.

17. A method for cleaning a visible surface of a vehicle as recited in claim 15, in which the step of arranging the vehicle electronic device within the housing chamber comprises the step of sizing and dimensioning the housing chamber to contain the vehicle electronic device.

18. A method for cleaning a visible surface of a vehicle as recited in claim 15, in which the step of connecting the transmission structure to the housing structure comprises the step of providing a transmission surface on the transmission structure such that signal waves associated with the vehicle electronic device may pass through the transmission surface.

19. A method for cleaning a visible surface of a vehicle as recited in claim 15, in which the step of arranging the at least one nozzle assembly to direct a stream of the pressurized fluid onto the transmission surface comprises the steps of:
providing the at least one nozzle assembly with at least one nozzle opening defined by the housing structure, and
configuring the at least one nozzle opening to direct the stream of pressurized fluid onto the transmission surface.

20. A method for cleaning a visible surface of a vehicle as recited in claim 15, in which in the which the step of arranging the at least one nozzle assembly to direct a stream of the pressurized fluid onto the transmission surface comprises the step of operatively connecting first and second nozzle assemblies to the housing structure such that:
the first nozzle assembly directs the fluid onto the transmission surface from a first direction; and
the second nozzle assembly directs the fluid onto the transmission surface from a second direction.
